(19) United States
(12) Patent Application Publication
(10) Pub. No.: US 2005/0193098 A1
(43) Pub. Date: Sep. 1, 2005

(54) Method and apparatus for selection of download technology

(75) Inventors: Vikram Khandpur, San Diego, CA (US); Paul Spadafora, Del Mar, CA (US); Ari J. Heinonen, San Diego, CA (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/789,250

(22) Filed: Feb. 27, 2004

(51) Int. Cl. G06F 15/177; G06F 15/16

(52) U.S. Cl. 709/220; 709/217

(57) ABSTRACT

A method and system for selecting a download technology for downloading information to a remote device. The method and system includes providing a communications operator with a plurality of different download technologies; transmitting data from the remote device to the communications operator for determining a download technology capability of the remote device by the communications operator; and automatically selecting one of the download technologies from the plurality of download technologies by the communications operator to download information to the remote device based upon the download technology capability of the remote device.

### BACKGROUND OF THE INVENTION

1. Field of the Invention

The present invention relates to a communications system and, more particularly, to a method and apparatus for selection of a download technology.

2. Brief Description of Prior Developments

One of the major sources of revenues for wireless operators is the download of content, such as ring tones, graphics, wallpapers, Java midlets, BREW applications, Symbian applications, and other types of content data. A problem exists in that there is a myriad of delivery solutions currently available such as BREW, Java, browser downloads and, more commonly, legacy solutions utilizing short message service (SMS) and smart messaging. Some of these solutions require that the handset be tailored to the wireless operator's solution. For example, an operator deploying a BREW distribution system for content download requires the mobile terminal to have a BREW client which can act as a download agent for the content data.

There is an absence of a content delivery solution which would work for most handsets; regardless of the handset manufacturer, model, it's technology support such as CDMA, GSM, WCDMA, etc and its content format support, such as .jpg, .gif, MIDI, etc. The problem is further emphasized when the terminal is a multi-mode terminal, such as a dual mode or a tri-mode terminal (each mode representing a different radio technology such as CDMA, GSM or WCDMA, etc) that can support different download technologies and different download agents in each mode. Due to the above-mentioned differences arising from different handset manufacturer, model, technology, and content format support, wireless operators are currently unable to serve the needs of its varied users with just one download technology.

When the wireless operator uses only one single download technology, the wireless operator limits the distribution of its content and distribution system to only the users that have the corresponding download capability in their mobile devices. As a result, the wireless operator would have to deploy different download methods and technologies. But there is no good solution in place that integrates these varied technologies, sharing a common database of content data, and which picks the most appropriate technology for the user's handset. Thus, currently, wireless operators are unable to provide an automatic content delivery mechanism for users which have different download technology capabilities. In the past, the content download has been implemented using different solutions by different operators. For example, some operators have deployed BREW downloads, or SMS/MMS downloads, or browser downloads as their distribution means.

The problem, therefore, such as in case of a BREW distribution system, the operator requires the handsets to have the BREW support and BREW download agent to be able to access the content on the operator's side and then initiate download of content. This limits the reach of the operator to handsets that only have the BREW support. Furthermore, the operator is not able to distribute the other content which does not require BREW support in the phone, such as ring tones, graphics, wallpapers, etc. This type of content data only needs the native support in the handset.

Some operators use short message service (SMS) or multimedia message service (MMS) to deliver content to the users' handsets. In the case of SMS/MMS as a means of content delivery, the user has to send a SMS with a certain code number to a certain destination address in a certain format to get the particular content; which then can be delivered via MMS or Enhanced Message Service (EMS), or SMS messages.

Some operators deliver content via browser downloads. The handset has a WAP or HTTP browser like openwave WAP browser or internet explorer. The user could manually launch the browser on his handset and enter the URL to download the content. Or alternatively in a handset containing SIM cards, the SIM toolkit application could automatically launch the “default browser” of the handset by sending the proactive SIM command “Launch Browser” containing the URL to go to. This URL could be dynamically received when the toolkit application communicates with the operator's server or it could be preprogrammed in a certain location in the memory of the SIM card. However, this “launch browser” commands limits the operator to use the default browser and not be able to choose a particular browser or download agents supported by the handset.

Subscriber identity module (SIM) toolkit applications have been extensively used by wireless operators to provide access to value added services of the wireless operator. The toolkit applications have been used to direct the user to the wireless operators portal using a default browser by launching the “launch browser” command which launches the default browser in the mobile equipment. A major drawback remains in this command and other communications between the SIM and the mobile equipment. When the SIM toolkit application wants to select a particular browser or download agent which is not the default, to initiate the most appropriate means for download, there is no support for that in the current specification between the SIM and the mobile equipment.

Moreover, to make sure to the SIM toolkit application that the Mobile equipment understands and executes such a command, there is no command in the current specifications from Mobile equipment telling the SIM of its capability to understand and execute such a command.

### SUMMARY OF THE INVENTION

In accordance with one method of the present invention, a method for selecting a download technology for downloading information to a remote device is provided comprising providing a communications operator with a plurality of different download technologies; transmitting data from the remote device to the communications operator for determining download technology capability of the remote device by the communications operator; and automatically selecting one of the download technologies from the plurality of download technologies by the communications operator to download information to the remote device based upon the download technology capability of the remote device.

In accordance with one aspect of the present invention, a download technology selection system is provided comprising a wireless communications operator comprising a plurality of different download technologies for downloading information to a plurality of wireless receiving devices; a system for determining download capabilities of each wireless receiving device; and a system for selecting one of the download technologies of the wireless communications operator for each respective wireless receiving device based upon the individual download capabilities of the respective wireless receiving devices.

In accordance with another aspect of the present invention, a mobile communications device is provided comprising a transceiver; a memory for storing download technology capabilities of the mobile communications device; and a system for transmitting, by the transceiver, the download technology capabilities of the mobile communications device, stored in the memory, to a wireless communications operator.

### BRIEF DESCRIPTION OF THE DRAWINGS

The foregoing aspects and other features of the present invention are explained in the following description, taken in connection with the accompanying drawings, wherein:

FIG. 1 is a diagram of a system incorporating features of the present invention;

FIG. 2 is diagram showing components of the system shown in FIG. 1;

FIG. 3 is a chart showing some of the steps of a method incorporating features of the present invention.

### DETAILED DESCRIPTION OF THE PREFERRED EMBODIMENTS

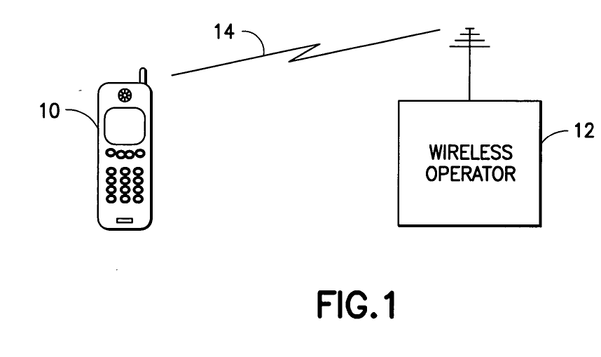

Referring to FIG. 1, there is shown a diagram of a mobile communications device 10 linked to a wireless operator 12 by a wireless link 14 incorporating features of the present invention. Although the present invention will be described with reference to the exemplary embodiment shown in the drawings, it should be understood that the present invention can be embodied in many alternate forms of embodiments. In addition, any suitable size, shape or type of elements or materials could be used.

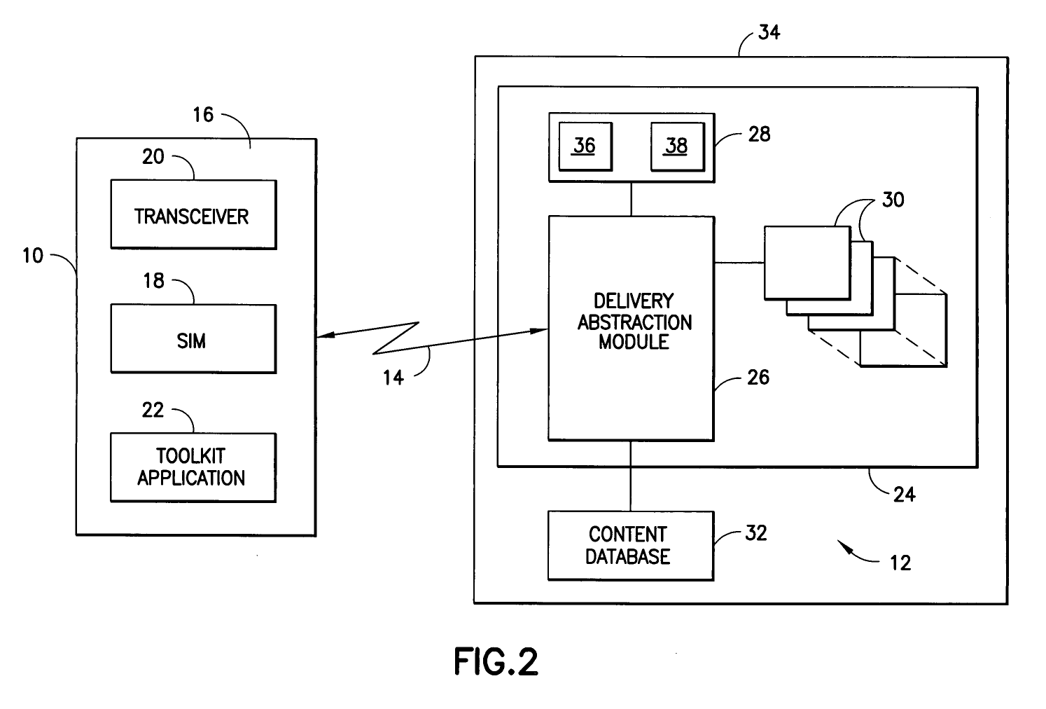

In the embodiment shown, the mobile communications device 10 comprises a mobile telephone handset. However, in alternate embodiments, the mobile communications device 10 could comprise any suitable type of mobile communications device, such as a PDA, a laptop computer, or a mobile game, for example. Referring also to FIG. 2, in this embodiment the handset 10 comprises mobile equipment 16 and a subscriber identity module (SIM) 18. The mobile equipment 16 includes a transceiver 20 connected to an antenna (not shown) for communicating by the wireless link 14 to the wireless operator 12. The SIM 18 is preferably removably connected to the mobile equipment. However, in an alternate embodiment, the SIM might not be removably connected. The handset 10 is also provided with a toolkit application 22. In a preferred embodiment of the present invention, the toolkit application 22 is embedded in the SIM 18. However, in an alternate embodiment, the toolkit application 22 could be provided with the mobile equipment 16; not on the SIM. The mobile equipment 16 preferably supports the basic proactive SIM commands of the SIM 18 and the toolkit application 22.

The wireless operator 12 comprises a conventional existing distribution system or operator's server side solution (34) and a delivery abstraction layer (DAL) 24 located functionally on top of the existing distribution system. The delivery abstraction layer 24 comprises a delivery abstraction module 26, a memory 28, and a plurality of download technologies 30. In an alternate embodiment, the memory 28 and the download technologies 30 could be incorporated into the existing distribution system and merely accessed by the delivery abstraction layer 24. The delivery abstraction module 26 is connected to a content database 32. An alternate embodiment, the content database 32 could be located in the delivery abstraction layer 24.

The memory 28 comprises a database of all of the operator's subscribers. In a preferred embodiment, the memory 28 comprises a first section 36 and a second section 38. The first section 36 preferably comprises the telephone number of each subscriber and the handset details for each handset of the subscribers, such as manufacturer and model. The first section 36 can also comprise a history of any requests and/or a history of downloads by the subscriber. The second section 38 of the memory 28 preferably comprises information such as handset capability in terms of wireless radio technology support (such as GSM, CDMA, TDMA, etc.), download capability support (such as BREW, Java, MMS, EMS, SMS, etc.), and content format support (such as MIDI, JPG, GIF, etc), etc.

The content database 32 can comprise a database of operator supplied downloads. For example, for the telephone handset 10 the downloads could comprise different types of tones, graphics, BREW applications, etc. The downloads could also be provided in the databases in different format types such as MIDI, JPG, GIF, etc. In an alternate embodiment, the content database 32 could comprise a connection to the Internet or to a remote content supplier.

The download agents 30 comprise various download technologies which the operator supports, such as Binary Runtime Environment For Wireless (BREW), Java, Enhanced Message Service (EMS), Multimedia Message Service (MMS), Short Message Service (SMS), for example, or any other suitable download technology. The delivery abstraction module 26 is adapted to communicate with the download agents 30.

The delivery abstraction module 26 is adapted to communicate with the toolkit application 22 in the handset 10 by means of the wireless link 14. In a preferred method, this communication can be by means of special SMS messages, such as using a proprietary format which is understood by both the toolkit application 22 and the delivery abstraction module 26. For example, in a GSM network, the special SMS messages could be class 2 SMS messages.

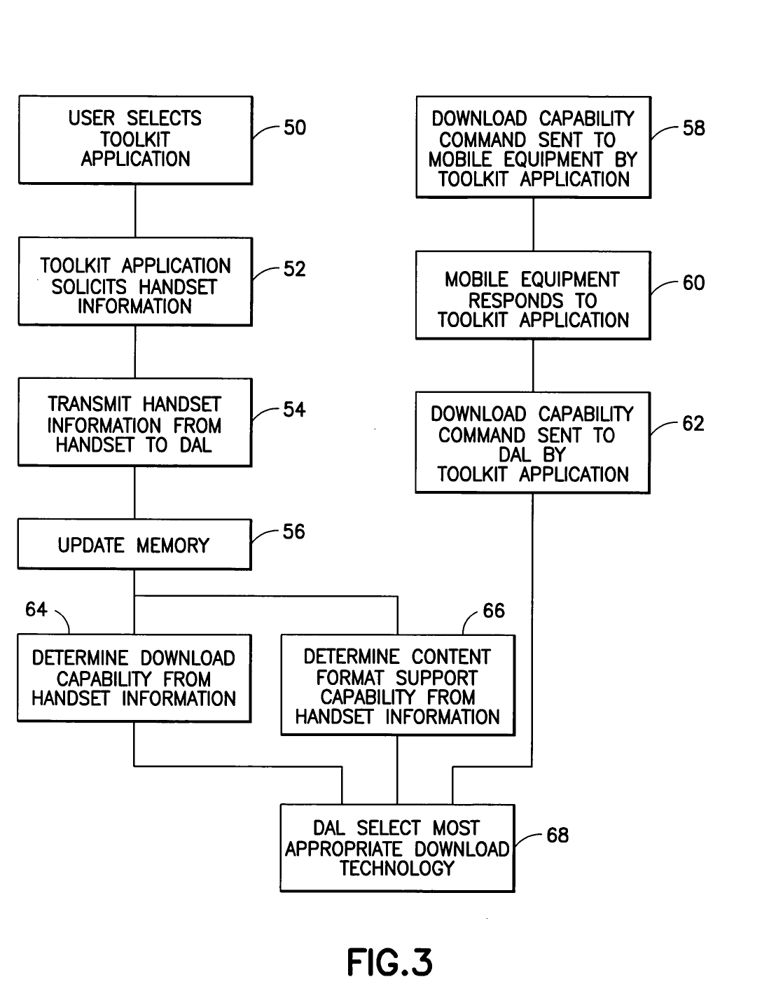

Referring also to FIG. 3, when the user first selects the toolkit application on the telephone handset 10 as indicated by block 50, the toolkit application preferably solicits handset information or remote device information from the user as indicated by block 52 using already existing SIM proactive commands such as SET UP MENU and SELECT ITEM. The handset information can include information such as the manufacturer of the handset and the model of the handset, for example. In an alternate embodiment, at least a portion of the handset information could be automatically communicated to the toolkit application by information already inside a memory of the mobile equipment. The handset information is transmitted from the telephone handset 10 to the delivery abstraction module (DAL) 26 as indicated by block 54.

Upon receiving the handset information from the handset 10 at the wireless operator 12, the delivery abstraction layer 24 preferably updates the first section 36 of the memory 28 with the user's handset information as indicated by block 56. The second section 38 of the memory 28 contains handset verses download capabilities, and handset verses content format support capabilities information. The DAL 24 can determine possible download capabilities from the handset information and use of the second section 38 of the memory 28 as indicated by block 64. The DAL can determine possible content format support capabilities from the handset information and use of the second section 38 of the memory 28 as indicated by block 66.

The toolkit application 22 also preferably sends a download capability command to the mobile equipment 16 as indicated by block 58. When the toolkit application 22 receives the response from the mobile equipment 16, the toolkit application informs the delivery abstraction layer 24 about the handset's download capabilities by means of a transport medium such as special SMS messages as indicated by blocks 60 and 62. The handset download capability command could also be sent from the mobile equipment 16 without a request from the SIM 18, such as a part of the “terminal profile” command or as a separate command during powering up of the handset when the handset is turned on by the user.

This separate command could also be sent some other time when the terminal download capability of the mobile equipment changes due to a switch to a different wireless radio technology or due to a change in the roaming status.

The information from the handset download capability command can be used in addition to the information stored in the second section 38 of the memory 28, or when the second section 38 does not comprise download capabilities of the handset. This information will be of great value when one of the known present download agents cannot be launched due to reasons such as the handset being a multi mode terminal and the download agent not supported in the active mode or if the user is roaming and the download agent not supported in the roam status.

The delivery abstraction layer 24 can look up in the database 32 the different contents which are available based upon the handset information provided by the handset 10. The delivery abstraction layer 24 can be responsible for presenting to the user the different contents available for download, and presenting the user with the content valid for the user's handset. When the user selects the content he wants to download, the toolkit application can convey the selection to the delivery abstraction layer, such as by using the special SMS messages described above, for example.

The delivery abstraction layer 24 can then decide the most appropriate download technology as indicated by block 68. The download technologies can include different selections of mode technology support (such as GSM, CDMA, TDMA, etc.), and/or download capability support (such as BREW, Java, MMS, EMS, SMS, etc.), and/or content format support (such as MIDI, JPG, GIF, etc), etc. This decision is preferably based on the details of the handset download capability provided by the toolkit application 22 to the delivery abstraction layer 24 and/or other parameters. For example, the other parameters can include:

Support of a certain download agent not present in the handset. For example, if the operator offers content via a BREW distribution system which requires a BREW download agent in the handset. The user could still be delivered content (such as songs, graphics, etc.) in the phone's supported format via other delivery methods, such as smart messaging, EMS or MMS for example (in the case the phone supports one of these).

User location status. In the case where the user is roaming, and a certain download agent such as a browser fails authentication or gateway access in the roaming partner's network, the other download technologies could be used.

Currently active technology. A handset could support more than one mode/wireless radio technology at a time, and could support different download agents in each mode technology. So the user could pick, and/or the operator could automatically pick, the suitable download agent in the phone and the most suitable delivery method. For example, in a dual mode GSM/CDMA handset, the phone could support MMS in GMS and BREW in CDMA. So when the handset is currently in the operator's CDMA network it could initiate a http session using BREW download agent for content delivery, and when the handset is active in the same operator's GSM network, it could deliver content via MMS. In a situation when a suitable agent is not present on the handset in the currently active technology, the network can communicate to the toolkit application to send a command to the phone to change modes and launch with some other appropriate agent. This change of technology could be done via a new command between the SIM and the mobile equipment. Or alternatively by a new command between the toolkit application and the Mobile equipment when the toolkit resides in the Mobile equipment and not on the SIM.

Encryption. If the user prefers to download data using a secure method, then the network could use a download agent that has a high level of security built into the delivery method.

Most appropriate technology selection could additionally or alternatively be based upon speed of delivery and/or the cost of delivery.

The delivery abstraction layer (DAL) 24 then performs one of the following actions:
Conveys the most appropriate technology to the toolkit application 22. The toolkit application 22 then sends the commands to launch the most appropriate download agent (such as launches the browser to the operator's download page for example); or
Uses the most appropriate technology to push the content directly to the handset without invoking the download agent on the handset (such as sends the content data via SMS for example).

In the first method noted above, instead of launching the download agent at that step, the launch of the most appropriate download agent could also happen after use of the most appropriate technology to push the content directly to the handset without invoking the download agent on the handset. The user could then browse content using the download agent instead of the toolkit application.

In an alternate embodiment of the present invention, the toolkit application could reside in the phone itself, such as a Java midlet, BREW application, or a native handset application, for example. The toolkit application could also reside outside of the phone, such as in a memory card for example. In such an embodiment, the phone is able to communicate with the delivery abstraction layer (DAL) 24 without use of the SIM. Besides SMS, the toolkit application could communicate by other means, such as USSD or DTMF for example.

Another command can be used to solicit the user's handset content format or MIME type capabilities that are downloadable over the air using its supported download technologies. An extension of this command can be used for a multi-mode handset to solicit its content format or MIME type capabilities that are downloadable over the air using its supported download technologies in its currently active mode. This will help eliminate the need for the second section 38 of the memory 28. It will also make the operator side easy to manage as it does not have to worry about each handset model and its supported formats. Although the present invention has been described in regard to the implementation for a GSM technology, it would be applicable to any technology, such as WCDMA, CDMA or TDMA for example.

The implementation described above is considered best when the toolkit application is provided in the SIM. There is no dependency on the handset software apart from the support of the download capability command. It also allows the user to conveniently change handsets. Most handsets supporting SIM cards already support Proactive SIM commands. That covers most of the requirements of the apparatus on the handset side.

The present invention provides a method and apparatus for the selection of the most appropriate download technology for a particular mobile equipment, such as a mobile radio telephone handset, for example. This enables easy content delivery so as to provide a one-stop shop for content. This can be regardless of phone model, manufacturer, supported delivery method/technology, and/or content format. The aim of the present invention is to make downloads easier for the user.

The present invention comprises a system which has a higher level delivery abstraction module. The higher level delivery abstraction module would preferably be located on top of an existing distribution system. The higher level delivery abstraction module would encompass the various download solutions, such as Binary Runtime Environment For Wireless (BREW), Enhanced Message Service (EMS), Multimedia Message Service (MMS), or Java, for example. This is referred to as the delivery abstraction layer (DAL). The higher level delivery abstraction module would pick the most appropriate one of the download solutions for the user's handset. The most appropriate method could also be decided on the factors mentioned above. A corresponding client on the mobile equipment or on the SIM side, such as a toolkit application, would be able to communicate to the delivery abstraction layer (DAL) and, hence, mutually cooperate to select the most appropriate means of download technology and initiating the corresponding download agent on the mobile equipment with a certain location or parameter.

As part of the method, a first command requesting the download capability of the mobile equipment can be sent from the SIM to the mobile equipment. A second command informing the SIM of the mobile equipment download capability can be sent from the mobile equipment to the SIM. This would help the toolkit application know about the various download agents available on the handset. The command informing the SIM of the mobile equipment capability could be sent in response to the request from the SIM or, could be sent without a request as part of a terminal profile download or as a separate command any other time during the communication between the SIM and the mobile equipment. As part of the method, an enhancement is provided over the existing command “launch browser” or a new command to launch a specific download agent and, not just the default browser which is the current limitation in the conventional “launch browser” command. The above commands could be exchanged between another application residing in either the phone itself or another medium, such as a smart card or a memory card. As part of the method, the toolkit application can communicate with the delivery abstraction layer (DAL) via SMS in a certain format known to both parties. This communication could also take place via other means, such as Unstructured Supplementary Service Data (USSD), Dual Tone Multi-Frequency (DTMF), etc.

The system described above enables mobile devices, such as mobile phones, to work with many delivery solutions even without having proprietary implementations in the handset microprocessor control unit (MCU) software. For example, a phone not having a BREW client could still get the contents that do not require native BREW support in the phone to run, being offered via an operator running a BREW distribution System (BDS). The delivery abstraction layer (DAL) could instruct the toolkit application to initiate the most appropriate download agent or directly send the content via a supported technology on the handset, such as MMS or SMS, if possible. For example, the operator could send MIDI songs via MMS instead. The system enables the operator to maximize the reach of the operator's existing distribution solution. For example, an operator could use the BREW distribution system to offer content downloads to handsets not running BREW client.

The present invention can provide the advantage of a comprehensive content delivery method which could work with most handsets supporting basic toolkit commands. The present invention can work with both CDMA and GSM phones. Thus, the present invention can provide a one-stop shop for the subscriber. The toolkit can enable the handset to work with different delivery solutions and hence insure that the user is able to download content data on his handset using any of the supported delivery solutions instead of just one. The subscriber does not need to care about his handset type and media formats which the handset supports. A database can keep a record of the users phone capabilities. A SIM or RUIM (Removable User Identity Module) card gives seamless transfer of content between handsets. For example, suppose a user transfers his telephone number from a BREW/Java/MIDI supporting advanced phone to an entry level phone handset supporting only NRT (Nokia Ringing Tones) tones and SMS downloads. With the solution of the present invention, the toolkit can present to the user his transferable download history allowing him to know which ones will be supported on the new handset.

The present invention can be used to automatically detect if a telephone handset has been changed. The present invention can then prompt the user to enter information about his new telephone handset. This can be done based on the Electronic Serial Number/International Mobile Equipment Identity (ESN/IMEI) that the phone sends when it registers with the network. The system can offer credits to a user for each download. The system can provide the user the ability to view his downloads versus a credit log. The present invention can provide the user with the ability to not only view the available content, but also set future notifications and execute searches. Eventually, when a single card could be used for both CDMA and GSM phones, the toolkit could support both technologies. This could be especially useful for an operator which has both technologies and deploys a different delivery solution in each technology. In an alternate embodiment, features of the present invention could be used in a non-wireless environment.

In the best case scenario, where it is mentioned that a SIM toolkit application communicates with the DAL, the communication is preferably via SMS. However, any suitable transport medium could be used. The other alternatives instead of SIM Toolkit application that are proposed could be clients like Java midlet or BREW applications that could be used to communicate with the DAL. This could be over SMS or a data connection. The idea is to use at least one existing transport mechanism to discover other transport mechanisms that the phone might support and, thereafter, the selection of the most appropriate available transport mechanism. It is after this point when the most appropriate technology has been selected that an Open Mobile Alliance (OMA) messaging aspect can come into play. OMA is a consortium of wireless companies that want to standardize various features to ensure interoperability between products.

The DAL is part of the network side. There will be changes required in a mobile device to supply the information that the SIM toolkit application or Java midlet (or some other application that communicates with the DAL) requires. A creation of these application program interfaces (APIS) for at least one SIM toolkit application is proposed. This information can include 1) the different download agents the handset supports, the different download download agents the handset supports in its current mode (varying with roaming status and the wireless radio technology which is active), and 2) its MIME type capabilities, its MIME type capabilities depending on the currently active wireless radio technology.

OMA downloading is based on SyncML DM protocol. So, contribution could be based on using SyncML DM for messaging between a mobile station and the network.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

1. A method for selecting a download technology for downloading information to a remote device, the method comprising:
providing a communications operator with a plurality of different download technologies;
transmitting data from the remote device to the communications operator for determining a download technology capability of the remote device by the communications operator; and
automatically selecting one of the download technologies from the plurality of download technologies by the communications operator to download information to the remote device based upon the download technology capability of the remote device.

2. A method as in claim 1 wherein the step of providing the communications operator with a plurality of different download technologies comprises providing at least two of the technologies from a group consisting of BREW distribution system, JAVA distribution system, MMS, SMS, EMS, and HTTP/WAP browser downloads.

3. A method as in claim 1 wherein the step of transmitting data from the remote device to the communications operator comprises transmitting remote device information including manufacturer and model of the remote device.

4. A method as in claim 3 further comprising storing the remote device information in a memory of the communications operator.

5. A method as in claim 3 wherein the data from the remote device to the communications operator comprises terminal download technology capability data comprising available download agents information.

6. A method as in claim 3 wherein the data from the remote device to the communications operator comprises terminal content format capability.

7. A method as in claim 1 wherein the remote device comprises a toolkit application, and wherein the toolkit application sends download technology capability data which is transmitted to the communications operator in the transmitting data from the remote device to the communications operator.

8. A method as in claim 7 wherein the download technology capability data sent by the toolkit application is stored in a memory of the communications operator.

9. A method as in claim 8 wherein the step of automatically selecting is based, at least partially, on the download technology capability data stored in the memory of the communications operator.

10. A method as in claim 9 wherein the step of transmitting data from the remote device to the communications operator comprises transmitting remote device information of manufacturer and model of the remote device, and wherein the remote device information is stored in the memory of the communications operator, and wherein the step of automatically selecting is based, at least partially, on the remote device information stored in the memory of the communications operator.

11. A method as in claim 1 wherein the data comprises wireless communication mode capability information of the remote device is stored in a memory of the communications operator.

12. A method as in claim 1 wherein the step of automatically selecting comprises use of at least one parameter selected from a group consisting of support of download agents, user location, wireless communication mode, encryption, speed of delivery and cost of delivery.

13. A download technology selection system comprising:
a wireless communications operator comprising a plurality of different download technologies for downloading information to a plurality of wireless receiving devices;
a system for determining download capabilities of each wireless receiving device; and
a system for selecting one of the download technologies of the wireless communications operator for each respective wireless receiving device based upon the individual download capabilities of the respective wireless receiving devices.

14. A download technology selection system as in claim 13 wherein the plurality of different download technologies comprising at least two of the technologies from a group consisting of BREW distribution system, JAVA distribution system, MMS, SMS, EMS, and HTTP/WAP browser downloads.

15. A download technology selection system as in claim 13 wherein the system for determining download capabilities of each wireless receiving device comprises a delivery abstraction module.

16. A download technology selection system as in claim 13 wherein the system for determining download capabilities of each wireless receiving device comprises a memory having information of manufacturer and model of the wireless receiving device stored in the memory.

17. A download technology selection system as in claim 13 wherein the system for determining download capabilities of each wireless receiving device comprises a memory having information of download technology capability data of the wireless receiving devices stored in the memory.

18. A download technology selection system as in claim 13 wherein the system for selecting one of the download technologies for use by the communications operator comprises use of at least one parameter selected from a group consisting of support of download agents, user location, wireless communication mode, encryption, speed of delivery and cost of delivery.

19. A mobile communications device comprising:
a transceiver;
a memory for storing download technology capabilities of the mobile communications device; and
a system for transmitting, by the transceiver, the download technology capabilities of the mobile communications device, stored in the memory, to a wireless communications operator.

20. A mobile communications device as in claim 19 further comprising a toolkit application, and wherein the toolkit application is adapted to send the download technology capabilities to the wireless communications operator.

21. A mobile communications device as in claim 20 further comprising a subscriber identity module (SIM), and wherein the toolkit application is stored in the SIM.

22. A mobile communications device as in claim 19 wherein the system for transmitting is adapted to transmit manufacturer and model information of the mobile communications device.

23. A mobile communications device as in claim 19 wherein the download technology capabilities comprise the download agents that are supported in the mobile communications device.

24. A mobile communications device as in claim 19 wherein the download technology capabilities comprise information of available download agents which can be used by the mobile communications device comprising at least two download agents selected from a group consisting of BREW based download agent, JAVA based download agent, MMS client, SMS client, EMS client, WAP or http web browsers.

25. A mobile communications device comprising:
a transceiver;
a memory for storing download technology capabilities of the mobile communications device; and
means for transmitting the download technology capabilities of the mobile communications device, stored in the memory, to a wireless communications operator.

26. A mobile communications device as in claim 25 further comprising a toolkit application, and wherein the toolkit application is adapted to send the download technology capabilities to the wireless communications operator.

27. A method for selecting a download technology for downloading information to a remote device, the method comprising:
a step for providing a communications operator with a plurality of different download technologies;
a step for transmitting data from the remote device to the communications operator for determining a download technology capability of the remote device by the communications operator; and
a step for automatically selecting one of the download technologies from the plurality of download technologies by the communications operator to download information to the remote device based upon the download technology capability of the remote device.

28. A program storage device readable by a machine, tangibly embodying a program of instructions executable by the machine for performing operations to select a download technology for downloading information to a remote device, the operations comprising:
receiving data from the remote device by a communications operator for determining a download technology capability of the remote device by the communications operator; and
automatically selecting a download technology from a plurality of download technologies by the communications operator to download information to the remote device based upon the download technology capability of the remote device.
